(19) United States
(12) Patent Application Publication
(10) Pub. No.: US 2024/0097980 A1
(43) Pub. Date: Mar. 21, 2024

(54) MANAGEMENT DEVICE, MANAGEMENT METHOD, AND MANAGEMENT PROGRAM

(71) Applicant: Nippon Telegraph and Telephone Corporation, Tokyo (JP)

(72) Inventors: Hiroki IWAHASHI, Musashino-shi, Tokyo (JP); Takahiro SHIBATA, Musashino-shi, Tokyo (JP); Toshiyuki KANAZAWA, Musashino-shi, Tokyo (JP); Masato NISHIGUCHI, Musashino-shi, Tokyo (JP)

(21) Appl. No.: 18/277,341

(22) PCT Filed: Feb. 16, 2021
(86) PCT No.: PCT/JP2021/005774

§ 371 Date: Aug. 15, 2023

(51) Int. Cl. H04L 41/084

(52) U.S. Cl. CPC H04L 41/084

(57) ABSTRACT

A common control unit (141A) acquires a configuration input request to a communication device accommodating a user using a network. An individual control unit (142A) identifies a variable group necessary for a command to execute the configuration input based on request content of the configuration input received by the common control unit (141A) and a type of communication device and transmits the identified variable group to the common control unit (141A). A command execution unit (143A) acquires the variable group identified by the individual control unit (141A) from the common control unit (141A), generates a command based on the acquired variable group, and executes the generated command.

### TECHNICAL FIELD

The present invention relates to a management device, a management method, and a management program.

### BACKGROUND ART

In the related art, a scheme of unitarily collecting and managing resources such as bands of communication devices forming a network, the number of filters that can be set, and the number of sessions that can be established, appropriately selecting communication devices accommodating users in accordance with idle resource of communication devices, and setting configurations in the devices is known (for example, see Non Patent Literature 1)

In the schemes of the related art, in order to guarantee ease of modification, the functions of generating a configuration and inputting commands to equipment are separated, and template files are provided for each of scenarios, making it possible to easily handle input specification changes and model additions.

### CITATION LIST

### Non Patent Literature

[Non Patent Literature 1] Iwahashi et al. “Consideration of Flexible User Accommodation on an Edge Router,” IEICE, General Conference 2020, B-6-58, March 2020
[Non Patent Literature 2] Iwahashi et al. “Proposal of Distributed Configuration of User Accommodation Flexibility System in Edge Router,”, IEICE Society Conference, B-6-1, September 2020.

### SUMMARY OF INVENTION

### Technical Problem

However, in the scheme of the related art, there is a problem that a change in a specification related to a setting of configuration to the communication device cannot be flexibly handled.

For example, in the scheme of the related art, it is conceivable that a change in a specification be reflected in a template for each scenario. However, actually, templates alone cannot handle major specification changes (addition of an IF protocol, a significant difference in a configuration generation logic, or the like) cannot be handled with only a template.

Further, if an entire device input function is newly developed and modified to handle a considerable change in a specification, high cost is incurred in a cooperative test with a higher-order function, a consistency test with an existing portion, or the like.

### Solution to Problem

In order to solve the foregoing problem and achieve the objective, a management device includes: a common control unit configured to acquire a configuration input request to a communication device accommodating a user using a network; an individual control unit configured to identify a variable group necessary for a command to execute the configuration input based on request content of the configuration input received by the common control unit and a type of communication device and to transmit the identified variable group to the common control unit; and a command execution unit configured to acquire the variable group identified by the individual control unit from the common control unit, generate a command based on the acquired variable group, and execute the generated command.

### Advantageous Effects of Invention

According to the present invention, it is possible to flexibly handle a change in a specification related to a setting of configuration in a communication device.

### BRIEF DESCRIPTION OF DRAWINGS

FIG. 1 is a diagram illustrating a configuration of a management system according to a first embodiment.

FIG. 2 is a diagram illustrating an example of a hierarchical structure managing a template.

FIG. 3 is a diagram illustrating an example of the hierarchical structure managing the template.

FIG. 4 is a sequence diagram illustrating a flow of processing of the management system according to the first embodiment.

FIG. 5 is a diagram illustrating an example of a computer executing a management program.

FIG. 6 is a diagram illustrating a configuration of a management system of the related art.

FIG. 7 is a diagram illustrating an example of preparation resources.

FIG. 8 is a diagram illustrating an example of consumption resources.

FIG. 9 is a diagram illustrating a configuration of a management system of the related art.

### DESCRIPTION OF EMBODIMENTS

Hereinafter, a management device, a management method, and a management program according to the present application will be described in detail with reference to the drawings. The present invention is not limited by the embodiments to be described below.

### Management System of Related Art

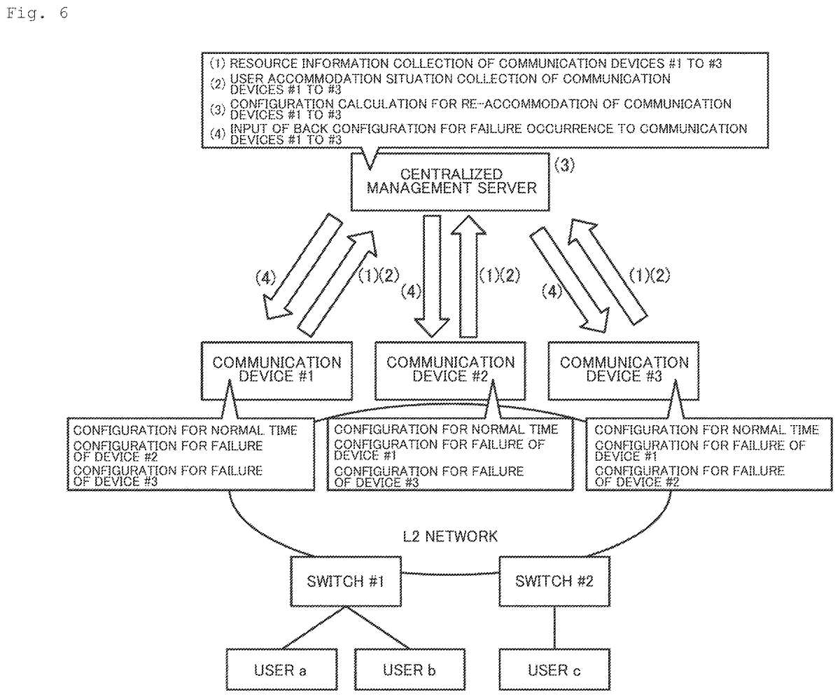

First, a management system of the related art will be described. FIG. 6 is a diagram illustrating a configuration of a management system of the related art.

As illustrated in FIG. 6, the centralized management server unitarily collects and manages resources such as the band of the communication device including a network, the number of filters that can be set, and the number of sessions that can be established. Further, a centralized management server appropriately selects a communication device accommodating a user in accordance with free resources of each communication device and sets user configuration in a corresponding device.

Further, the centralized management server simultaneously sets a backup of the user configuration in other communication devices in advance and immediately switches the communication device when the accommodation device fails. Each communication device holds backups of other communication devices.

The centralized management server rearranges an accommodation position and a configuration backup position of a user depending on a resource situation appropriately when a new user is accommodated or resource information is collected. In this way, by flexibly recombining the accommodation positions of the users in accordance with a communication state of the communication device, it is possible to prevent a resource shortage and keep communication quality of the user constant.

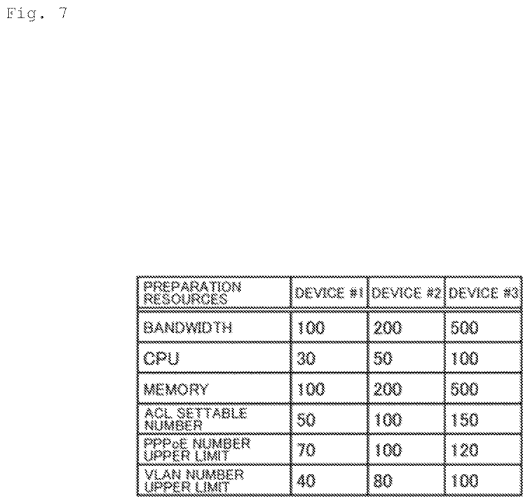

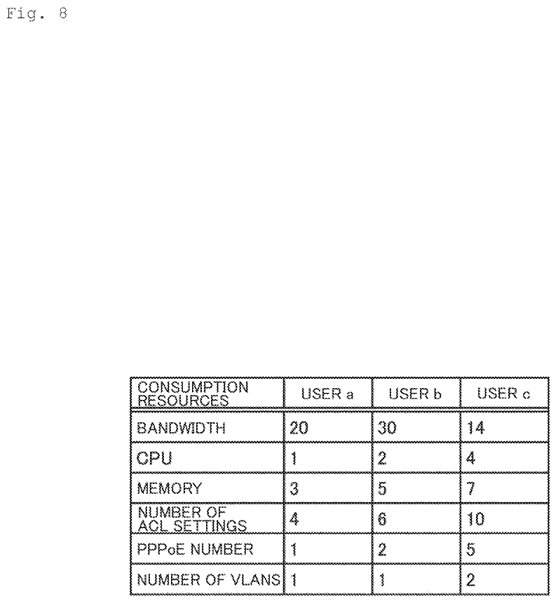

For example, the centralized management server manages the preparation resources illustrated in FIG. 7 and consumption resources illustrated in FIG. 8. FIG. 7 is a diagram illustrating an example of the preparation resources. FIG. 8 is a diagram illustrating an example of the consumption resources. The centralized management server manages each communication device so that the consumption resources do not exceed the preparation resources.

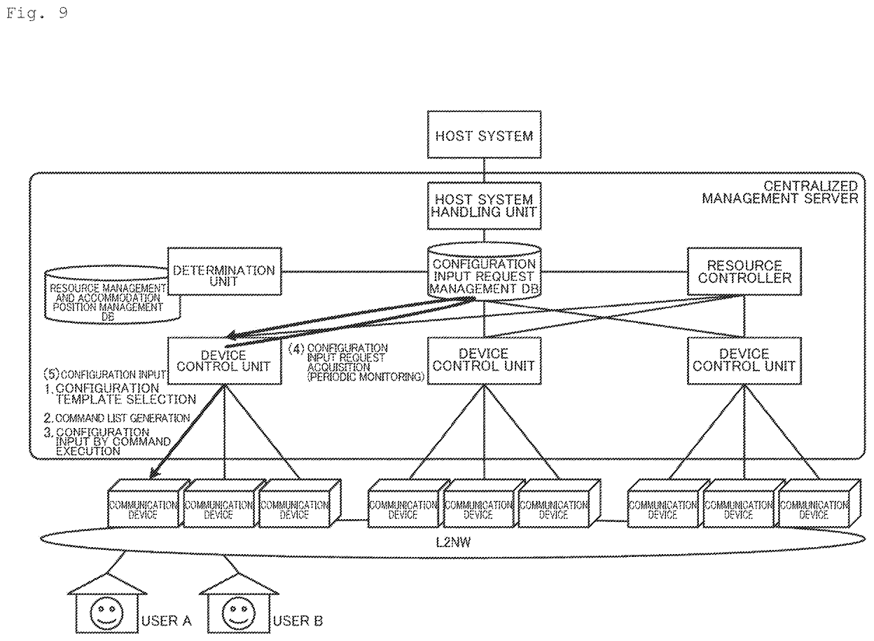

Another management system of the related art will be described. FIG. 9 is a diagram illustrating a configuration example of the management system of the related art.

As illustrated in FIG. 9, by separating the device control unit and the determination unit managing resources and determining an accommodation position, it is possible to easily handle a change in a command associated with addition of a new service, a change in a specification of a communication device, an introduction of a new model, or the like.

However, the management system of the related art may not flexibly handle a change in the specification. For example, as described above, a considerable change in the specification cannot be handled with only a template used in the device control unit. When an entire function is newly developed and modified, high cost is incurred.

Further, in a case where a device in which there is already a control system has to be newly controlled, such as a case where an existing system or network is integrated, or a case where there is a dedicated control device in a vendor, a new development portion and an existing control system overlap each other, and therefore extra cost is incurred.

Although it is conceivable that a device control unit for each type of communication device be prepared, it is difficult to handle a change in an operation when a version and a use purpose are different.

One of the objectives of the present embodiment is to cause the device control unit to handle a change in a specification flexibly.

### Structure of First Embodiment

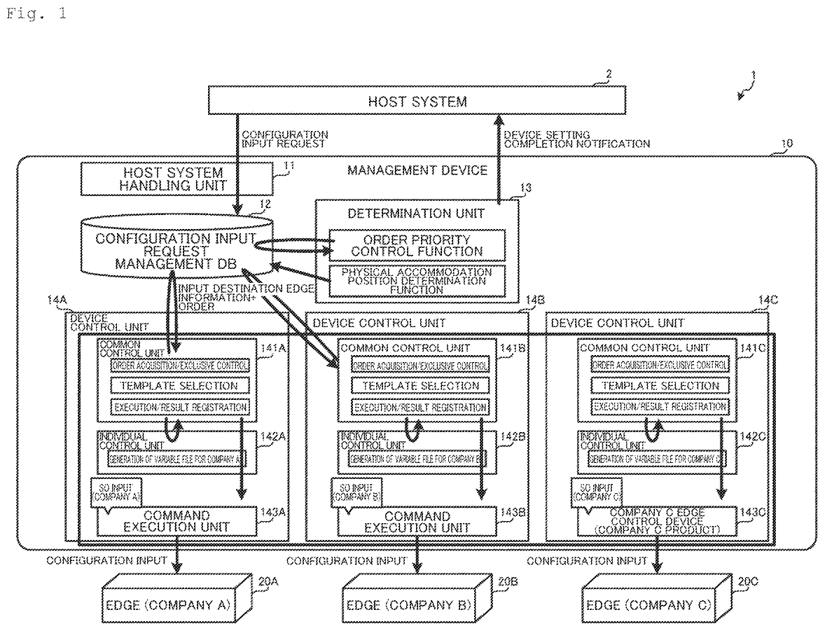

First, a configuration of a management system according to a first embodiment will be described with reference to FIG. 1. FIG. 1 is a diagram illustrating an exemplary configuration of a management system according to the first embodiment. As illustrated in FIG. 1, a management device 10, an edge 20A, an edge 20B and an edge 20C are provided. An edge is an example of a communication device. Each edge accommodates a user who uses a communication service. Companies A, B, and C are examples of users. The communication device may be a switch, a router, or the like.

The management device 10 receives a configuration input request from the host system 2. The configuration input request may be termed a service order (SO).

A function of the host system 2 may be implemented by an operator. In this case, the operator inputs content of the configuration input request to the management system 1. As a configuration input, a setting is executed in a communication device accommodating a user in accordance with opening, change, cancellation or the like of a service.

As illustrated in FIG. 1, the management device 10 includes a host system handling unit 11, a configuration input request management DB 12, a determination unit 13, a device control unit 14A, a device control unit 14B, and a device control unit 14C.

Here, the management device 10 may be implemented by a plurality of computers or may be implemented by one computer. Each of the configuration input request management DB 12, the determination unit 13, the device control unit 14A, the device control unit 14B and the device control unit 14C may be implemented by a physical machine or a virtual machine.

First, the host system handling unit 11 receiving the configuration input request from the host system 2 registers the received configuration input request in the configuration input request management DB 12. Thus, the configuration input request management DB 12 stores the request content of the configuration input to a plurality of communication devices accommodating users using the network.

The determination unit 13 performs priority control of an order (configuration input request) stored in the configuration input request management DB 12, determination of a physical accommodation position of a user, and the like.

The device control unit 14A, the device control unit 14B, and the device control unit 14C perform similar processing. Here, the device control unit 14A will be described as an example.

The device control unit 14A includes a common control unit 141A, an individual control unit 142A, and a command execution unit 143A.

The common control unit 141A acquires a request for a configuration input to a communication device accommodating a user using a network. For example, the common control unit 141A acquires a configuration input request (order) from the configuration input request management DB 12 and performs exclusive control on the acquired order.

Further, the common control unit 141A acquires information regarding the edge of an input destination. The information on the edge of the input destination includes the model, version, application, etc. of the edge.

Further, the common control unit 141A calls the corresponding individual control unit 142A from the scenario information of the order.

The individual control unit 142A identifies a variable group necessary for a command to execute a configuration input based on the request content of the configuration input received by the common control unit 141A and the type of communication device and transmits the identified variable group to the common control unit 141A. The type of communication device is, for example, a model of an edge.

The individual control unit 142A writes the identified variable group in a variable file and transmits the variable file to the common control unit 141A.

Here, the common control unit 141A instructs a command execution unit 143 to generate and execute a command by using the variable file received from the individual control unit 142A as an argument.

The command execution unit 143A acquires the variable group identified by the individual control unit 142A from the common control unit 141A, generates a command based on the acquired variable group, and executes the generated command.

Here, the command execution unit 143A holds a template for each type of communication device, a version of the communication device, and a use of the communication device, and generates a command based on the template.

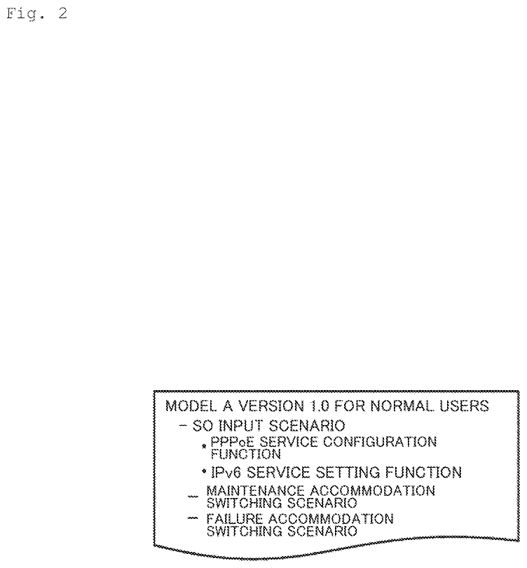

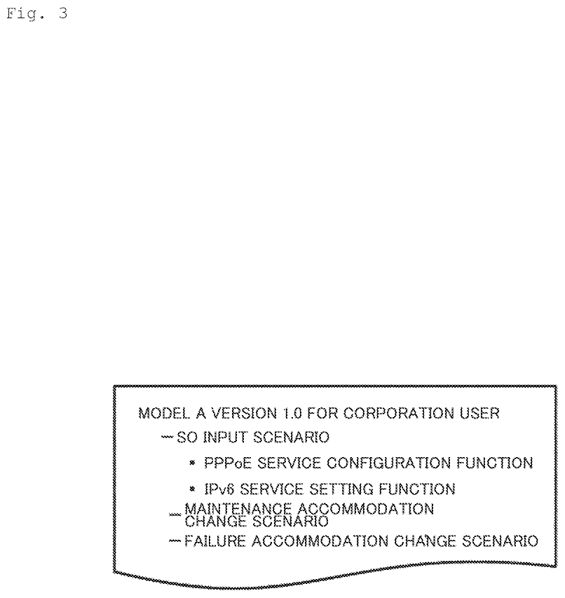

FIGS. 2 and 3 are diagrams illustrating examples of hierarchical structures managing templates. As illustrated in FIGS. 2 and 3, the templates are managed for each type, version, and use of the communication device.

In FIG. 2, as templates of which a model is “model A,” a version is “1.0,” and a use is “for a normal user,” it is indicated that there are templates corresponding to a “SO input scenario,” a “maintenance accommodation switching scenario” and a “failure accommodation switching scenario,” respectively.

Further, in the “SO input scenario,” there are a “PPPoE service setting function” and an “IPv6 service setting function” as function branches in the scenario. Even in the scenario, the presence or absence of a setting for each service is changed in response to a request of each user, or a setting order is considered depending on a device specification in some cases. Therefore, such function branches are set.

On the other hand, FIG. 3 illustrates a template in which a model is “model A,” a version is “1.0,” and a use is “for corporation user.” The template in FIG. 2 and the template in FIG. 3 have a common model and version, but different uses.

The command execution unit 143A transmits a log related to the execution of a command to the common control unit 141A. At this time, the common control unit 141A stores a result of the configuration input in the configuration input request management DB 12 based on the log transmitted by the command execution unit 143A.

### Processing in First Embodiment

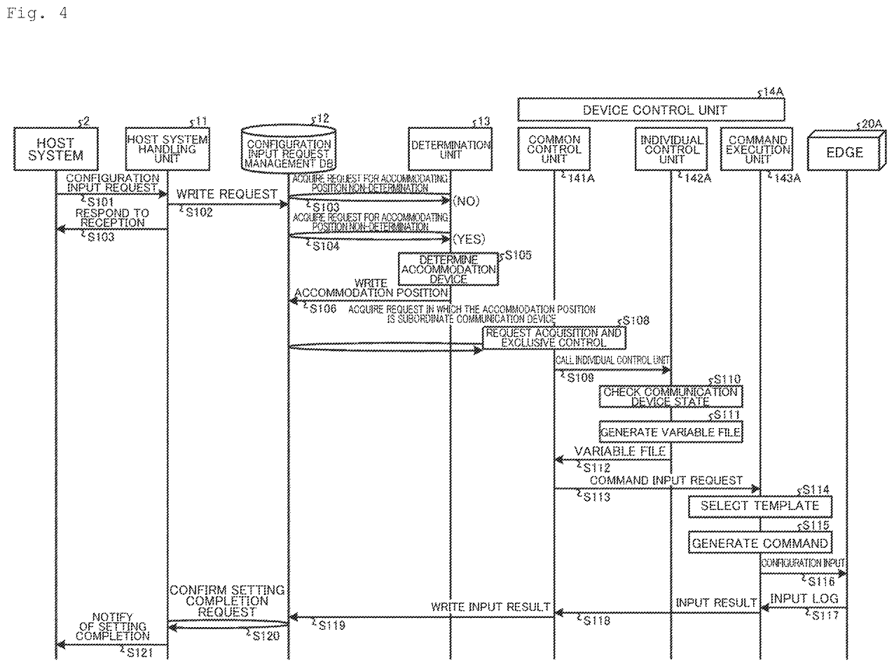

FIG. 4 is a sequence diagram illustrating a flow of processing in the management system according to the first embodiment. First, as illustrated in FIG. 4, the host system handling unit 11 receives a configuration input request from the host system 2 (step S101). Subsequently, the host system handling unit 11 writes the received configuration input request in the configuration input request management DB 12 (step S102).

The determination unit 13 periodically attempts to acquire a request for accommodation position non-determination from the configuration input request management DB 12 (steps S103 and S104). In this case, the determination unit 13 determines an accommodation position (step S105) when a request for accommodation position non-determination can be acquired (in the case of Yes).

The determination unit 13 writes the accommodation position in the configuration input request management DB 12 (step S106). The common control unit 141A acquires a request in which the accommodation position is a subordinate communication device of the device control unit 14A and performs exclusive control (step S108). The subordinate communication device of the device control unit 14A is, for example, the edge 20A.

Here, the common control unit 141A calls the individual control unit 142A (step S109). The individual control unit 142A checks a state of the communication device (the edge 20A) (step S110) and generates a variable file (step S111). Then, the individual control unit 142A transmits the generated variable file to the common control unit 141A (step S112).

The common control unit 141A performs a command input request to the command execution unit 143A based on the variable file. (step S113). The command execution unit 143A selects a template based on the command input request (step S114).

The command execution unit 143A generates a command based on the selected command template (step S115). Then, the command execution unit 143A executes the generated command on the edge 20A and performs configuration input (step S116).

Here, the command execution unit 143A acquires the input log from the edge 20A (step S117) and transmits the acquired input log to the common control unit 141A as an input result (step S118).

The common control unit 141A writes an input result in the configuration input request management DB 12 (step S119). The host system handling unit 11 confirms a setting completion request to the configuration input request management DB 12 (step S120). Then, the host system handling unit 11 notifies the host system 2 of the completion of the setting (step S121).

### Effects of the First Embodiment

As described above, the common control unit 141A acquires the request of the configuration input to the communication device accommodating the user using the network. The individual control unit 142A identifies a variable group necessary for a command to execute the configuration input based on the request content of the configuration input received by the common control unit 141A and the type of communication device, and transmits the identified variable group to the common control unit 141A. The command execution unit 143A acquires the variable group identified by the individual control unit 142A from the common control unit 141A, generates a command based on the acquired variable group, and executes the generated command.

In this way, the function of the device control unit 14A is divided into three units of the common control unit 141A, the individual control unit 142A, and the command execution unit 143A.

For example, when a slight change occurs in a command due to the change in the specification, the template held by the command execution unit 143A is edited. Such handing can be implemented at low cost as in the related art.

On the other hand, even when a considerable change in the specification or model addition occurs, there is a case where this can be handled with only the modification of the individual control unit 142A and the command execution unit 143A without modifying the common control unit 141A. In this way, in the present embodiment, it is possible to minimize an influence of the change due to the change in the specification.

By replacing only the command execution unit 143A, an existing system such as other OSS and a manager only for a vendor can be diverted. Thus, a reduction in development cost and an early introduction are possible. For example, the device control unit 14C in FIG. 1 is a form in which the command execution unit is replaced with an edge control device manufactured by company C.

As described above, according to the present embodiment, it is possible to flexibly handle a change in the specification related to the setting of configuration in the communication device.

The command execution unit 143A holds a template for each type of communication device, each version of the communication device, and each use of the communication device and generate a command based on the template. Thus, by managing the templates in the hierarchical structure, it is possible to minimize an influence on other units when the setting order in the scenario is changed or the setting content of each service is changed.

The command execution unit 143A transmits a log related to the execution of the command to the common control unit 141A. The common control unit 141A stores the result of configuration input in the configuration input request management DB 12 based on the log transmitted by the command execution unit 143A. Thus, even if the function of the device control unit 14A is divided, the execution result of the configuration input can be shared by each unit.

[System Structure and the Like]

The constituents of the devices illustrated in the drawings are functional concepts, and may not necessarily be physically configured as illustrated in the drawings. That is, specific forms of the distribution and integration of the devices are not limited to the illustrated forms. All or some of the forms of the distribution and integration of the devices can be distributed or integrated functionally or physically in any unit in accordance with various loads, usage situations, or the like. Further, all or some of the processing functions executed at the devices may be implemented by a CPU and a program analyzed and executed by the CPU, or may be implemented as hardware through wired logic.

All or some of the steps of the processing described as being performed automatically among the steps of the processing described in the present embodiment can be performed manually, and alternatively, all or some of the steps of the processing described as being performed manually can be performed automatically in accordance with known methods. In addition, information including the processing procedures, control procedures, specific names, and various types of data or parameters illustrated in the above literature or drawings can be arbitrarily changed unless otherwise described.

Program

As an embodiment, the management system 1 can be mounted by installing a management program executing the detection processing in a desired computer as packaged software or on-line software. For example, an information processing device can function as the management system 1 by causing the information processing device to execute the detection program. Here, the information processing device includes a desktop or laptop personal computer. Further, a mobile communication terminal such as a smartphone, a mobile phone, or a personal handyphone system (PHS), or a slate terminal such as a personal digital assistant (PDA), for example, is included in a category of the information processing device.

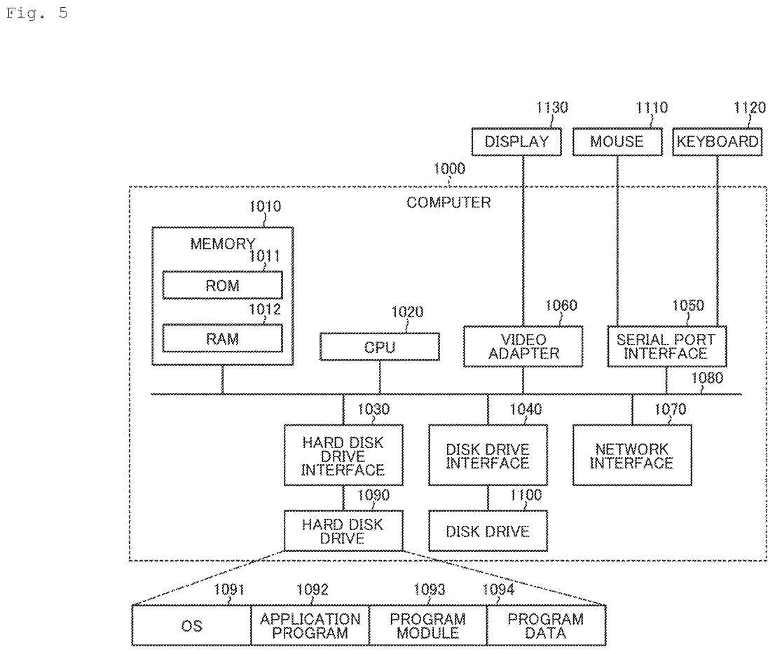

FIG. 5 is a diagram illustrating an example of a computer executing the management program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a ROM (Read Only Memory) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each processing of the management device which has a function similar to that of the management system 1 is mounted as the program module 1093 on which computer-executable codes are defined. The program module 1093 is stored in, for example, the hard disk drive 1090. For example, the program module 1093 performing the same processing as the functional structure of the device is stored in the hard disk drive 1090. The hard disk drive 1090 may also be replaced by a SSD.

Setting data used in the processing of the above-described embodiments is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012, as necessary, and executes the processing of the above-described embodiment.

The program module 1093 or the program data 1094 is not limited to being stored in the hard disk drive 1090, and may be stored, for example, in a detachably mounted storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and program data 1094 may be read from another computer via the network interface 1070 by the CPU 1020.

### REFERENCE SIGNS LIST

N Communication network
1 Management system
2 Host system
10 Management device
11 Host system handling unit
12 Configuration input request management DB
13 Determination unit
20A, 20B, 20C Edge
14A, 14B, 14C Device control unit
141A, 141B, 141C Common control unit
142A, 142B, 142C Individual control unit
143A, 143B: Command execution unit
143C Edge control device

1. A management device comprising:
a common control unit implemented using one or more computing devices, configured to acquire a configuration input request to a communication device accommodating a user device using a network;
an individual control unit implemented using one or more computing devices, configured to;
identify a variable group for a command to execute the configuration input based on request content of the configuration input received by the common control unit and a type of communication device, and
transmit the identified variable group to the common control unit; and
a command execution unit implemented using one or more computing devices, configured to;
acquire the variable group identified by the individual control unit from the common control unit,
generate a command based on the acquired variable group, and
execute the generated command.

2. The management device according to claim 1, wherein the command execution unit is configured to:
retain a template for each type of communication device, each version of the communication device, and each use of the communication device, and
generate the command based on the template.

3. The management device according to claim 1,
wherein the command execution unit is configured to transmit, to the common control unit, a log related to execution of the command, and
wherein the common control unit is configured to store a result of the configuration input in a database based on the log transmitted by the command execution unit.

4. A management method executed by a management device including a common control unit, an individual control unit, and a command execution unit, the method comprising:
acquiring a configuration input request to a communication device accommodating a user device using a network, by the common control unit;
identifying, by the individual control unit, a variable group for a command to execute the configuration input based on request content of the configuration input received by the common control unit and a type of communication device;
transmitting the identified variable group to the common control unit, by the individual control unit;
acquiring, by the command execution unit, the variable group identified by the individual control unit from the common control unit;
generating, by the command execution unit, a command based on the acquired variable group; and
executing the generated command by the command execution unit.

5. A non-transitory recording medium storing a management program, wherein execution of the management program causes one or more computers to perform operations comprising:
acquiring a configuration input request to a communication device accommodating a user device using a network;
identifying a variable group for a command to execute the configuration input based on request content of the configuration input and a type of the communication device;
generating a command based on the variable group; and
executing the generated command.
